(19) United States
(12) Patent Application Publication
(10) Pub. No.: US 2011/0091711 A1
(43) Pub. Date: Apr. 21, 2011

(54) CARBON NANOSTRUCTURES FROM ORGANIC POLYMERS

(75) Inventors: David J. Neivandt, Bangor, ME (US); Jonathan Mark Spender, Enfield, ME (US); Xinfeng Xie, Old Town, ME (US); Lucas D. Ellis, Bangor, ME (US)

(73) Assignee: University of Maine System Board of Trustees, Bangor, ME (US)

(21) Appl. No.: 12/908,672

(22) Filed: Oct. 20, 2010

Related U.S. Application Data
(60) Provisional application No. 61/253,229, filed on Oct. 20, 2009.

(51) Int. Cl. B32B 5/18; C08H 7/00; B29C 39/02; B29C 39/38; B32B 5/00; B32B 5/02; B82Y 30/00; B82Y 40/00

(52) U.S. Cl. 428/304.4; 530/500; 264/28; 425/317; 428/332; 977/755; 977/742; 977/788; 977/900; 62/340

(57) ABSTRACT

Methods and apparatuses for forming carbon nanostructures from a polymer mixture. The methods include the steps of mixing the pre-formed polymer with a liquid to form a polymer mixture, freezing the polymer mixture at an effective freezing rate greater than or equal to 10³ Kelvin per second to form a polymer cast within the frozen liquid, separating the polymer cast from the frozen liquid by sublimating the frozen liquid, and carbonizing the polymer cast to form a carbon nanostructure. Variations of these methods are included in the scope of the invention and produce materials with varying properties. Through control of the freezing process, the nanomorphology of the resultant structure may be modulated. Nanostructures formed according to these methods are also claimed.

### CROSS-REFERENCE TO RELATED APPLICATIONS

This application claims priority under 35 U.S.C. §119 to U.S. Provisional Application No. 61/253,229, filed on Oct. 20, 2009, which is herein incorporated by reference in its entirety.

### BACKGROUND OF THE INVENTION

1. Technical Field

The present invention generally relates to methods and apparatuses for forming nanostructures and nanostructures made accordingly. More particularly, the present invention relates to methods and apparatuses for creating consistent carbon nanostructures from organic polymers and nanostructures made accordingly.

2. Background Information

Carbon based nanostructures are recognized as having useful mechanical, chemical, electrical, thermal, and adsorptive properties that are directly attributable to their particular geometry and dimension. For this reason, carbon based nanostructures have been combined with more conventional materials to enhance their functional properties. Although best known as a light weight filler for improving the strength of composites, applications for materials incorporating carbon based nanostructures also include batteries, capacitors, sensor elements, scanning probe microscopy tips, micro electromechanical systems, gene delivery devices, filter membranes, gas storage media, and catalyst supports. Carbon based nanomaterials have also been used as carbide ceramic nanoparticle precursors.

The functional properties of certain materials have been attributed to specific geometric features of carbon nanostructure compositions. For instance, relatively long, fibrous nanostructure morphology is associated with improved tensile strength in various materials. Common geometric features of carbon nanostructure compositions might include fibers, tubes, cones, spheres, platelets, and sheets. Such structures may be formed individually or may be produced together in variously ordered combinations and ratios.

Carbon nanostructures have traditionally been produced by a variety of technologies including physical extrusion, chemical vapor deposition, arc discharge, laser vaporization, and porous silica template imprinting. In general, these technologies require carbon based feed stock to build an underlying polymer. Ethylene gas, rayon, coal and oil pitches, polyvinyl alcohol, and polyacrylonitrile have commonly been used as polymer precursors. More recently, researchers have been motivated to use existing technology to produce carbon nanostructures from lignin. See Lallave, M. et al., 2007 “Filled and hollow carbon nanofibers by coaxial electrospinning of Alcell lignin without binder polymers” Advanced Materials, Vol. 19, No. 23, 4292-4292, see also Loscertales I. G. et. al., 2007 “Coaxial Electrospinning for Nanostructured Advanced Materials” MATERIALS RESEARCH SOCIETY SYMPOSIUM PROCEEDINGS, VOL 948, pages 83-90. In comparison to other carbon feedstocks, lignin is potentially more economical. However, even with lignin as a feedstock, existing methods are generally too complex, too difficult to scale, and/or too energy intensive for producing low cost carbon nanomaterials.

Therefore, there is a need for a fast, safe, and economical process for supporting the manufacture of carbon nanomaterials which provides satisfactory control over the structural morphology of the final product.

### SUMMARY OF THE INVENTION

Briefly, the present invention satisfies the need for a fast, safe, and economical process for supporting the manufacture of carbon nanomaterials which provides control over the structural morphology of the final product.

The present invention provides, in a first aspect, a method of forming a carbon nanostructure from a pre-formed polymer including the steps of mixing the pre-formed polymer with a liquid to form a polymer mixture, freezing the polymer mixture at an effective freezing rate greater than or equal to 10³ Kelvin per second to form a polymer cast within the frozen liquid, separating the polymer cast from the frozen liquid by sublimating the frozen liquid, and carbonizing the polymer cast to form a carbon nanostructure.

Aspects of the invention are characterized by incorporating relatively non-toxic preformed polymers that are freeze cast under specific conditions to purposely affect the geometry and dimension of the polymer matrix before the matrix is sublimated and carbonized. Freezing rate and concentration of polymer mixtures are correlated with distinct morphologies of templated polymer matrices.

The present invention provides, in a second aspect, a method of forming a carbon nanostructure including the steps of: mixing a monomer, oligomer, or combination thereof with a liquid, polymerizing the monomer, oligomer, or mixture thereof in the liquid to form a polymer mixture, freezing the polymer mixture at an effective freezing rate greater than or equal to 10³ Kelvin per second to form a polymer cast within the frozen aqueous solution, separating the porous polymer cast from the frozen aqueous solution by sublimating the frozen aqueous solution, and carbonizing the porous polymer cast to form a carbon nanostructure.

The present invention provides, in a third aspect, an apparatus for forming carbon nanostructures including: a means for freezing a liquid solution or suspension, hereinafter called a liquid mixture, at an effective freezing rate greater than or equal to 10³ Kelvin per second, a means for depositing the liquid mixture on said means for freezing a frozen liquid mixture, and a means for receiving the frozen liquid mixture, wherein the liquid mixture is a polymer mixture.

The present invention provides, in a fourth aspect, a method of forming substantially non-aggregated nanofibers including the steps of: suspending an organic polymer, or fibers containing organic polymers, in a liquid suspension to form a polymer mixture, freezing the polymer mixture at an effective freezing rate greater than or equal to 10³ Kelvin per second to form a polymer cast within the frozen liquid; and separating the porous polymer cast from the frozen aqueous solution by sublimating the frozen aqueous solution to form substantially non-aggregated nanofibers.

These, and other objects, features and advantages of this invention will become apparent from the following detailed description of the various aspects of the invention taken in conjunction with the accompanying drawings.

### BRIEF DESCRIPTION OF THE DRAWINGS

FIG. 1 shows a scanning electron micrograph of a sublimated lignin cast formed from an aqueous solution that was rapidly flash frozen by contact with a liquid nitrogen cooled steel plate.

FIG. 2 shows a scanning electron micrograph of a sublimated polyacrylic acid cast formed from an aqueous solution that was rapidly flash frozen by injection into liquid nitrogen.

FIG. 3 shows a scanning electron micrograph of a sublimated lignin cast formed from an aqueous solution that was rapidly flash frozen in liquid nitrogen-cooled isopentane.

FIG. 4 shows a scanning electron micrograph of a sublimated lignin cast formed in an aqueous solution that was slowly dipped into liquid nitrogen.

FIG. 5 shows a scanning electron micrograph of a sublimated lignin cast formed in a sample of aqueous solution that was rapidly flash frozen by injection into liquid nitrogen.

FIG. 6 shows a scanning electron micrograph of a carbonized nano structure matrix made from sublimated lignin cast formed from an aqueous solution that was rapidly flash frozen in liquid nitrogen.

FIG. 7 shows a scanning electron micrograph of a carbonized nanostructure matrix made from the lignin cast material of FIG. 4.

FIG. 8 shows the adsorption of nitrogen at 77K on the nanocarbon material (carbonized at 900 C without stabilization).

FIG. 9 shows a typical thermogravimetric analysis profile for carbonization of freeze-dried lignin nano material in nitrogen.

FIG. 10 shows an X-ray photoelectron spectroscopy spectra of a carbon nanomaterial (carbonized at 900 C without stabilization).

FIG. 11 shows the oxygen 1s high-resolution, fitted spectra of a carbon nano material (carbonized at 900 C without stabilization).

FIG. 12 shows carbon is high-resolution, fitted spectra of a carbon nanomaterial (carbonized at 900 C without stabilization).

FIG. 13 shows near-edge X-ray absorption fine structure (NEXAFS) spectra of a carbon nanomaterial heated to 1000 C without oxidative stabilization. Highly ordered pyrolytic graphite (HOPG) was used as a calibration.

FIG. 14 shows a scanning electron micrograph of a sublimated lignin cast formed from an aqueous solution that was rapidly flash frozen by contact with a liquid nitrogen cooled steel drum.

FIG. 15 shows a scanning electron micrograph of the sublimated lignin cast of FIG. 14 at a higher magnification.

FIG. 16 shows a scanning electron micrograph of the sublimated lignin cast of FIG. 14 at a higher magnification.

FIG. 17 shows a picture of an apparatus of one aspect of the invention.

FIG. 18 shows a scanning electron micrograph of largely non-aggregated cellulose nanofibers/nanocrystals.

### DETAILED DESCRIPTION OF THE INVENTION

The present invention provides for methods and apparatuses for producing carbon nanostructures in a fast and reliable way that allows a user to control the morphology of nanostructures produced. The following description is intended to provide examples of the invention and to explain how various aspects of the invention relate to each other. However, it is important to note that the scope of the invention is fully set out in the claims and this description should not be read as limiting those claims in any way.

The inventors have discovered that the morphology of nanoscale carbon structures created from a polymer stock may be modulated by controlling the freezing rate of the material in a liquid. Through the use of extremely controlled freezing, the invention allows for the creation of desired geometries and dimensions of nanostructures within the polymer cast by using the frozen crystals of the liquid to order the polymer in the mixture.

For the purposes of this disclosure, the following terms are specifically defined. Terms used in this disclosure but not explicitly defined herein should be given the meaning commonly attributed to the term by those of skill in the art.

The term “carbonize” as used herein refers to heating at a sufficient temperature and for a long enough period of time to degrade polymer casts such that the relative proportion of carbon in the cast is substantially increased, for example, increased by at least 40%.

The term “flash freezing” as used herein refers to rapid freezing, such as, for example, at an effective freezing rate of 10³ Kelvin per second or greater, and, as a further example, freezing accomplished by contact with liquid nitrogen.

The term “freeze cast polymer” or “cast polymer” or “cast” or “polymer cast” as used herein refers to a polymer as part of a matrix having a geometry which has resulted from a polymer being dissolved or suspended in a suitable liquid and frozen therein. The cast may thereafter be sublimated, carbonized, further heat treated, and/or “graphitized”.

The term “effective cooling rate” as used herein refers to the change in energy in a system over a particular period of time represented as a pure temperature change of liquid phase water, wherein the energy involved in the change of matter state is converted to an equivalent temperature change of liquid state.

The term “graphitization” as used herein refers to the solid state transformation of thermodynamically unstable non-graphitic carbon into graphite by thermal activation, such as, for example, by heating a carbonized cast at temperatures above 1200 degrees Celsius in an inert atmosphere.

The term “high yield” as used herein refers to a process that produces a polymer matrix or cast, which when carbonized at between 800 and 900 degrees Celsius by conventional methods results in carbon nano-structures comprising greater than 25% carbon.

Herein, “inert atmosphere” refers to a gas or mixture of gases having a depleted concentration of oxygen such that normal combustion is substantially inhibited.

The term “macroporous” as used herein refers to structures having pores larger than 50 nm.

The term “mesoporous” as used herein refers to structures having pores which are between 2 and 50 nm.

The term “microporous” as used herein refers to structures having pores smaller than 2 nm. Similarly, “micropores” as used herein refers to pores smaller than 2 nm.

The term “mixture” as used herein refers to a substantially homogenous solution, suspension, or combination of solution and suspension of polymers, or fibers composed of polymers, in a liquid medium.

The term “preformed” or “preformed polymer” as used herein refers to an oligomer or a molecule of which at least a polymer backbone has been formed before entering the process mixture of the present invention.

All scanning electron micrograph (SEM) images were obtained after sputtering samples with gold to form a layer approximately 10-18 nanometers thick on the surface of the samples. This was done to stabilize the nanostructures resulting from the methods of the present invention in order to be able to capture appropriate images of the structure.

The present invention, in one aspect, includes a method of forming a carbon nanostructure from a pre-formed polymer comprising the steps of mixing the pre-formed polymer with a liquid to form a polymer mixture, freezing the polymer mixture at an effective freezing rate greater than or equal to 10³ Kelvin per second to form a polymer cast within the frozen liquid, separating the polymer cast from the frozen liquid by sublimating the frozen liquid, and carbonizing the polymer cast to form a carbon nanostructure.

Polymers that may be used within the scope of the invention include lignin, carboxymethylcellulose, polyacrylic acid, cellulose, natural polymers, modified natural polymers, synthetic polymers, homopolymers of polyacrylates, homopolymers of polysulfonates, homopolymers of polyphosphates, copolymers of polyacrylates, copolymers of polysulfonates, copolymers of polyphosphates, polyacrylic acid, polymethacrylic acid, polystryrenesulfonic acid, guar and xanthan gums, cationic, anionic amphoteric and non-ionic starch, polyvinyl alcohol, polyethylene oxide, polyacrylonitrile, proteins, polysaccharides, polyethylene, polypropylene, polytetrafluoroethane, polyethyleneteraphthalate, polyvinylacetate, polyvinyl chloride, nylon, elastomers, polyesters and polyacrylimide, among others. Polyelectrolytes, water soluble polymers, and polymers that may be suspended in water are all contemplated as within the scope of the invention as well. Polymers may be mixed in various concentrations prior to freezing depending on the characteristics of the polymer cast desired to be achieved. Polymer mixtures may be solutions, suspensions, or combinations of both. Polymers may be mixed with liquid in such concentrations that at least a portion of polymer is suspended rather than dissolved in the solvent. Water and other liquids capable of forming substantially organized polymer casts may be used to make the polymer mixtures. Furthermore, these liquids may be supplemented with specific additives or solutes to help aid mixing, provide direction to the polymer cast formation, or impart specific functional properties to the final carbonized nano-structure. Polymer matrices produced by these methods may be made from mixtures of polymer precursors that are organized into oligomers and backbone structures during the course of mixing. Such polymers are understood to be formed in situ. Polymers formed prior to mixing or formed in situ are both contemplated to be within the scope of the invention. Polymers within the scope of the invention may be formed from monomers, oligomers, or a combination thereof.

Freezing of the polymer mixture according to aspects of the invention are a special form of ice templating. In general, ice templating relies on the natural structure of ice crystals to form an organized polymer matrix and is less complicated and energy intensive than other matrix forming methods. As the name suggests, the technique involves dissolving or suspending polymer precursors in water and freezing the homogeneous mixture. As the mixture freezes, ice crystals displace the polymer material in an orderly fashion. The frozen water is separated from the polymer matrix structure by sublimation. Once dried, the polymer matrix is commonly referred to in the art as a cryogel. See Gutierrez, M. C. et al., 2008, “Ice-Templated Materials: Sophisticated Structures Exhibiting Enhanced Functionalities Obtained after Unidirectional Freezing and Ice-Segregation-Induced Self Assembly”, Chemistry of Materials, Vol. 20, n^{o}3, pp. 634-648. The inventors have surprisingly discovered that if the entirety of a sample is frozen at or above a particular effective freezing rate, hierarchical changes in morphology that are typically observed in ice templating studies may be avoided.

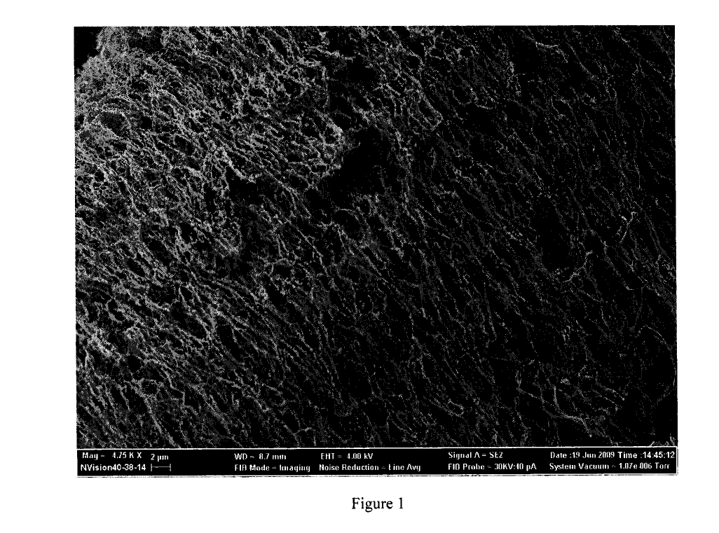

Effective freezing rates within the scope of the invention include effective freezing rates of between about 10³ Kelvin per second and about 10⁵ Kelvin per second. Methods of the present invention allow for a high proportion of nanofibers exhibiting a substantially uniform morphology. An example of material formed using methods within the scope of the present invention may be found in FIG.1. In FIG. 1, a lignin polymer was rapidly frozen using a liquid nitrogen cooled steel plate. The resultant structure resembles a substantially consistent non-woven mat-type structure wherein the nanofibers are longitudinally oriented in the direction of the freezing front.

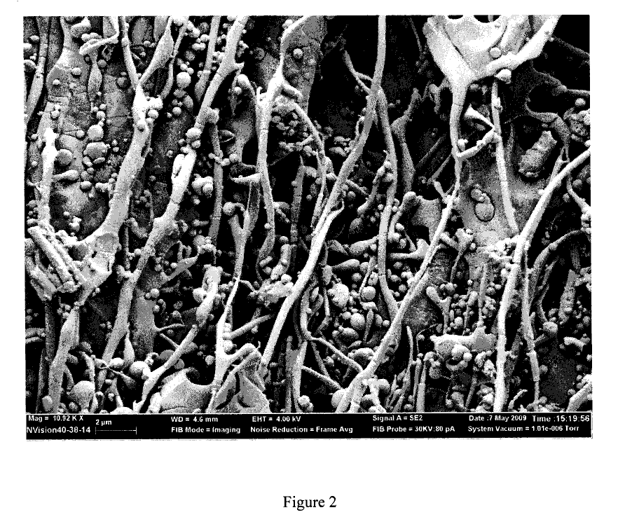

The use of differing polymers is also within the scope of the invention and an example of the method of the present invention being applied using polyacrylic acid may be seen in FIG. 2. Specifically, FIG. 2 shows the structure resulting from the rapid freezing of a polyacrylic acid cast by injecting a polyacrylic acid mixture directly into a liquid nitrogen bath. Due to fluctuations in the rate at which the polyacrylic acid mixture was frozen, one can observe a more diverse structure when compared to the sample in FIG. 1. For example, significant amounts of both nanofibers and nanospheres are found in FIG. 2, while only nanofibers are present in significant amounts in the sample shown in FIG. 1.

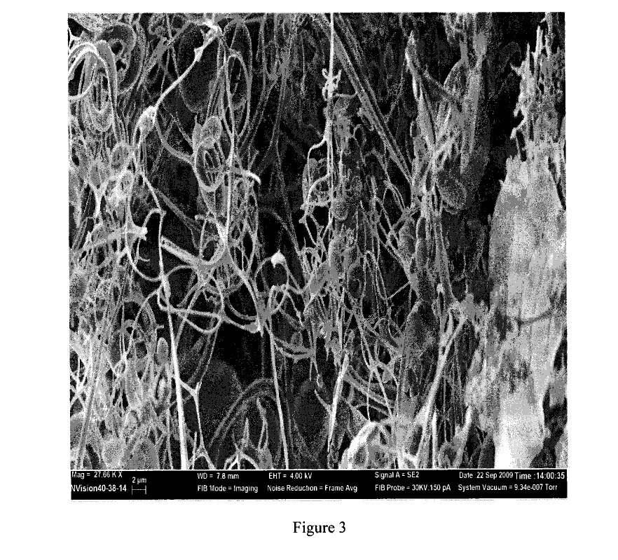

The use of different methods of cooling was also discovered to have modulating effects on the resultant carbon nanostructures produced according to aspects of the invention. Specifically, FIG. 3 shows a frozen lignin cast that was frozen using liquid nitrogen-cooled isopentane. One may observe from FIG. 3 that the slight variation in the rate of freezing produced significantly different structures than those found in FIGS. 1-2. While not wishing to be held to any particular theory, the difference in the rate of effective freezing between liquid nitrogen and isopentane may be due to the isopentane being warmer than liquid nitrogen during these experiments, leading to a greater change in morphology due to the smaller effective cooling rate. The inventors contemplate that isopentane, with appropriate modification of freezing parameters, should produce excellent nanostructures due to isopentane's higher boiling temperature and resistance to volatilization, thus avoiding the Leidenfrost effect that may be occurring with certain uses of liquid nitrogen.

Subsequent to freezing of the polymer cast, the polymer cast may be separated from the frozen liquid through sublimation, leaving the isolated polymer cast. Sublimation can be accomplished using standard techniques including freeze-drying under vacuum.

Carbonization of sublimed polymer casts may be accomplished inside a closed furnace with inert or non-oxidizing atmospheres comprising argon, nitrogen, hydrogen, helium, or mixtures thereof and is preferably carried out at between 800 and 1000 degrees Celsius. Additional methods, temperatures, and equipment for carbonizing carbon materials are well known to persons skilled in the art.

Aspects of the invention will also incorporate an additional step into the methods described above wherein the polymer cast is stabilized subsequent to the separating step and prior to the carbonizing step. Specifically, the polymer cast may first be preheated or stabilized by heating slowly to temperatures between 200 and 300 degrees Celsius before being carbonized. For example, approximately 2 to 3 mls. of templated, sublimated lignin may be preheated at a rate of approximately 15-30 degrees Celsius per hour. In general, the appropriate rate of preheating is effected by the amount and packing density of polymer material, and the flow rate of gas used for the process.

Additional aspects of the invention may include the additional step of graphitizing the carbonized polymer. Methods, temperatures, and equipment for graphitizing carbon materials are well known to persons skilled in the art. As an example, graphitizing the polymer cast may include heating the polymer cast in an inert atmosphere to temperatures greater than 1200 degrees Celsius for a period of time.

The methods of the present invention are suitable for producing high-yield carbon nanostructures that are 25% or more carbon by weight. Aspects of the invention, for example, methods using lignin as the polymer with a carbonization temperature of between about 800 to about 900 degrees Celsius, are suited to producing even higher yield carbon nanostructures that are 40% or more carbon by weight.

A range of polymer concentrations in the polymer mixture is contemplated as within the scope of the invention. Specifically, about 0.01 wt % to about 2.5 wt % polymer is desirable for producing controlled and consistent nanostructures from polymer casts as described in this disclosure.

Another aspect of the invention includes the nanostructures produced according to the methods described in this disclosure. Such nanostructures may include planar sheets, fibrous mats, fibers, micropores, mesopores, tubes, spheres, platelets, and cones in different ratios and configurations. Gradients or discrete regions of these or other nanostructures are also contemplated as within the scope of the invention. Preferably, about 90% by volume, or more, of the nanostructures produced are substantially similar in shape and/or distribution across the entire polymer cast and or carbonized cast.

The present invention, in another aspect, includes a method of forming a carbon nanostructure comprising the steps of: mixing a monomer, oligomer, or combination thereof with a liquid, polymerizing the monomer, oligomer, or mixture thereof in the liquid to form a polymer mixture, freezing the polymer mixture at an effective freezing rate greater than or equal to 10³ Kelvin per second to form a polymer cast within the frozen aqueous solution, separating the porous polymer cast from the frozen aqueous solution by sublimating the frozen aqueous solution, and carbonizing the porous polymer cast to form a carbon nanostructure.

All of the equivalents and aspects described above, for example, discussion of suitable polymers and exploration of the freezing, separating and carbonizing steps, among others, may be similarly employed in these aspects of the invention. The major difference between the aspects of the current invention described in the above paragraph and those described further above are that the polymer is not formed prior to addition to the liquid, but is formed during or after addition.

The present invention, in another aspect, includes an apparatus for forming carbon nanostructures comprising: a means for freezing a liquid material at an effective freezing rate greater than or equal to 10³ Kelvin per second, a means for depositing the liquid material on the means for freezing forming a frozen liquid material, a means for receiving the frozen liquid material, wherein the liquid material is a polymer mixture.

A variety of means for freezing the liquid polymer mixture material is contemplated to be within the scope of the invention. Examples include providing a thin layer of liquid nitrogen, for example, as a coating on a rotating drum; providing a suitably cooled non-vaporizing liquid; or providing a sufficiently cooled gas. Additionally, the inventors contemplate the use of any application-appropriate cryogenic liquid, or material cooled by any cryogenic liquid, as within the scope of the invention including, but not limited to, liquid nitrogen, liquid helium, liquid ethane, and liquid methane.

A variety of means for depositing the liquid material on the freezing means are also contemplated as within the scope of the invention. Such means for depositing include a pressurized stream of material being ejected from a nozzle, needle, or aperture; gravity-based methods of depositing the polymeric mixture; spin coating, metering the mixture with a blade, and others. Additionally, the means for depositing the liquid material on the freezing means is understood to also mean a means for introducing the frozen liquid material to the means for freezing, creating contact between the frozen liquid material and the means for freezing, and a means for exposing the frozen liquid material to the means for freezing the liquid material.

Any means suitable for receiving the frozen liquid polymer mixture material are within the scope of this aspect of the invention. Such means include tubs, beakers, bags, buckets, and electrostatic methods, among others.

The present invention, in yet another aspect, includes a method of forming substantially non-aggregated nanofibers comprising the steps of: suspending an organic polymer, or fibers containing organic polymers, in a liquid suspension to form a polymer mixture, freezing the polymer mixture at an effective freezing rate greater than or equal to 10³ Kelvin per second to form a polymer cast within the frozen aqueous solution; and separating the porous polymer cast from the frozen aqueous solution by sublimating the frozen aqueous solution to form substantially non-aggregated nanofibers.

Suitable organic polymers for use within this aspect of the invention include lignin, carboxymethylcellulose, polyacrylic acid, cellulose, natural polymers, modified natural polymers, synthetic polymers, homopolymers of polyacrylates, homopolymers of polysulfonates, homopolymers of polyphosphates, copolymers of polyacrylates, copolymers of polysulfonates, copolymers of polyphosphates, polyacrylic acid, polymethacrylic acid, polystryrenesulfonic acid, guar and xanthan gums, cationic, anionic amphoteric and non-ionic starch, polyvinyl alcohol, polyethylene oxide, polyacrylonitrile, proteins, polysaccharides, polyethylene, polypropylene, polytetrafluoroethane, polyethyleneteraphthalate, polyvinylacetate, polyvinyl chloride, nylon, elastomers, polyesters and polyacrylimide, among others. Polyelectrolytes, water soluble polymers, and polymers that may be suspended in water are all contemplated as within the scope of the invention as well.

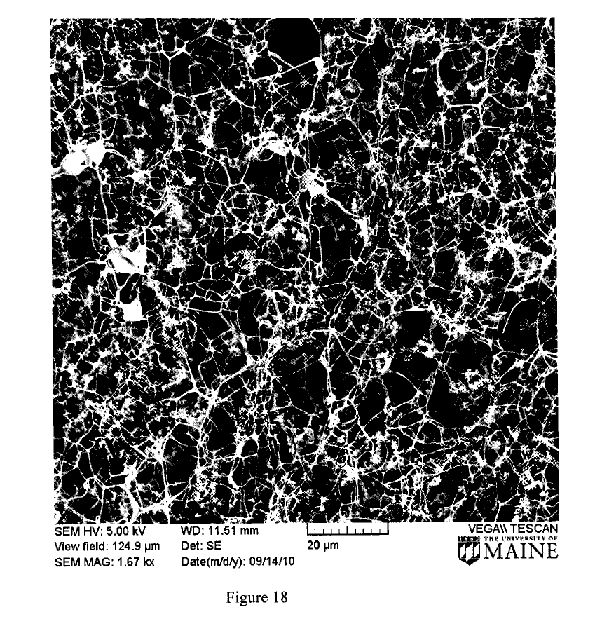

As compared to previously described aspects of the invention, the lack of a carbonizing step in this aspect allows for the production of largely or substantially non-aggregated fibers in atmosphere, as opposed to solution. Unlike the prior art, wherein exposure to the atmosphere would result in significant aggregation of fibers, the controlled freezing and sublimation steps of the present invention allow the resultant fibers to remain substantially non-aggregated. An example of a nanostructure produced according to this aspect of the invention may be found in FIG. 18. FIG. 18 shows that the nanofibers/nanocrystals formed according to this aspect of the invention are largely non-aggregated.

As used in this aspect of the invention, the term “non-aggregated” means that the fibers produced according to this aspect of the invention are if in contact with one another, the contact is essentially pointwise, that is, large portions of the fibers are not in contact with portions of other fibers.

### EXAMPLES

### 1. Production of Disordered Porous Lignin Matrix

A 0.2% aqueous mixture of MWV Indulin AT lignin by weight was made by combining the polymer with a pH 9.5 NaOH aqueous solution in a glass beaker, and stirring the mixture for 90 minutes at approximately 70 degrees Celsius. After stirring, the mixture was allowed to cool slowly to room temperature.

Approximately 2 to 3 milliliters (ml) of the mixture was further cooled by slowly submerging the beaker into liquid nitrogen until completely frozen.

The templated frozen polymer mixture was removed from the nitrogen and the frozen water sublimated in a freeze drying apparatus (SP Industries, model No. FM35EL-85) under partial vacuum of 15 mtorr for approximately 6-8 hours.

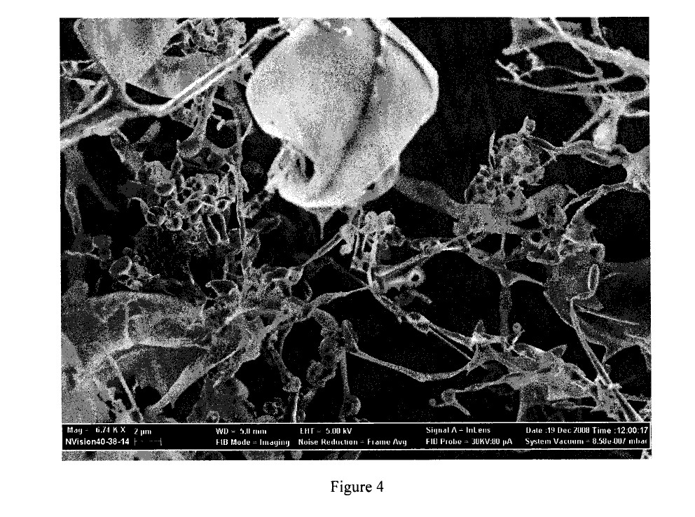

As is depicted in FIG. 4, a scanning electron micrograph of the resulting lignin cast shows multiple morphological features including fibers, spheres, platelets, and cones in the templated lignin matrix. The polymer framework is relatively disordered and not especially dense. Most notably, the scanning electron micrograph (SEM) shown in FIG. 4 shows consistently spaced pores of various sizes completely penetrating the polymer matrix.

### 2. Production of Lignin Carbon Nanofibers

Lignin (Indulin AT, MeadWestvaco) was dissolved in alkaline aqueous solutions in concentrations ranging from 0.1-2.2 wt. %. Base concentrations ranged from 1.4-10.0 wt. %, with the base itself comprising either sodium hydroxide or ammonium hydroxide. Lignin dissolution was aided by heating the solution in a round bottom flask immersed in an oil bath at a temperature of approximately 80° C. for 2-8 hours with constant stirring ranging from 160-370 revolutions per minute (RPM). Solutions were then cooled to ambient temperature prior to freezing.

Solutions were directly injected using a 23-guage needle into numerous cryogenic media or onto substrates cooled by cryogenic media (see Rapid Cooling Conditions 1-4).

The frozen water was subsequently sublimed off employing a VirTis freezemobile 35 EL. Samples were maintained under vacuum and kept at approximately −80° C. for 6-20 hours. Upon completion of freeze drying the nano structured lignin sample was brought to ambient temperature and atmosphere.

Lignin samples that were subsequently carbonized employed a temperature gradient of 10° C./min up to a maximum temperature of 1000° C. All sample images presented are scanning electron micrographs recorded on a Zeiss NVision 40 SEM.

### Rapid Cooling Condition 1:

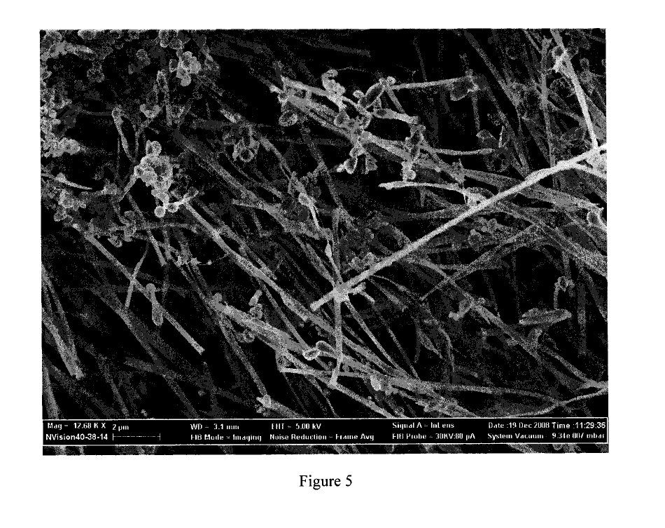

The solution was prepared in a round bottom flask and comprised approximately 1.40 grams (g) lignin, 2.8 ml of 1M sodium hydroxide and 700 ml water. A magnetic stir bar was employed to constantly stir the sample at 360 RPM in a 68° C. oil bath. The solution was heated for 120 minutes before being cooled to ambient temperature and subsequently injected into liquid nitrogen. After freezing, the frozen water was sublimed. FIG. 5 presents an SEM image of the sample post-sublimation.

### Rapid Cooling Condition 2:

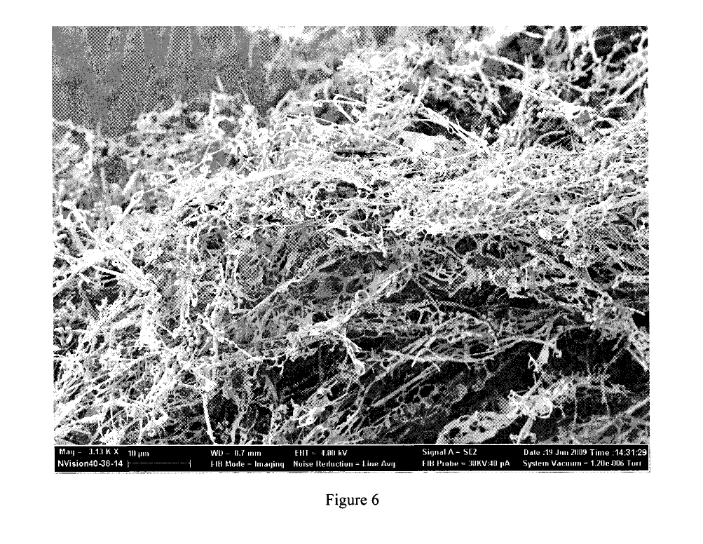

The solution was prepared in a round bottom flask and comprised approximately 0.10 g lignin, 0.75 g sodium hydroxide and 50 g water. A magnetic stir bar was employed to constantly stir the sample at 360 RPM in an 80° C. oil bath. The solution was heated for 120 minutes before being cooled to ambient temperature and subsequently injected into liquid nitrogen. After freezing, frozen water was sublimed for approximately 18 hours. The sample was subsequently carbonized. FIG. 6 presents an SEM image of the sample post-carbonization.

### Rapid Cooling Condition 3:

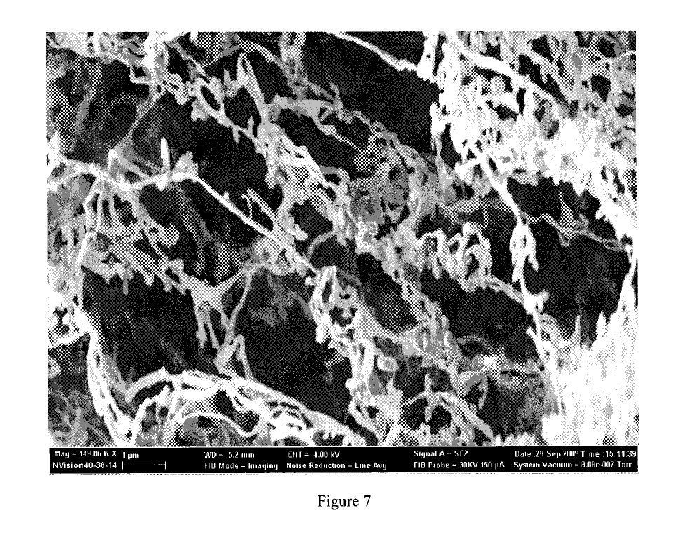

The solution was prepared in a round bottom flask and comprised approximately 3.0 g lignin, 152 g ammonium hydroxide and 1.36 L water. A magnetic stir bar was employed to constantly stir the sample at 225 RPM in an 80° C. oil bath. The solution was heated for 120 minutes before being cooled to ambient temperature and subsequently injected into liquid nitrogen-cooled isopentane. After freezing, frozen water was sublimed for approximately 14 hours. The sample was subsequently carbonized. FIG. 3 was recorded prior to carbonization, while FIG. 7 was recorded post-carbonization.

### Rapid Cooling Condition 4:

The solution was prepared in a round bottom flask and comprised approximately 0.10 g lignin, 0.75 g sodium hydroxide and 50 g water. A magnetic stir bar was employed to constantly stir the sample at 360 RPM in an 80° C. oil bath. The solution was heated for 120 minutes before being cooled to ambient temperature and subsequently injected onto a liquid nitrogen-cooled steel plate. After freezing, frozen water was sublimed for approximately 18 hours. FIG. 1 is an SEM image recorded prior to carbonization.

As demonstrated by the SEM images of example 3, rapidly frozen lignin casts are characterized as porous mats with distinctively high proportions of elongated fibers. Other features include a significantly smaller proportion of spheres in comparison to casts formed in lignin mixtures that were not as rapidly cooled. Moreover, the images show that carbon nanostructures produced from rapidly frozen lignin casts retain substantially the same ordered, dense, and fibrous morphologies as the casts from which they derive. Carbon nanomaterial produced from flash frozen freeze-dried lignin of the present invention was further characterized as follows:

### Adsorption Isotherm of Nitrogen at 77K:

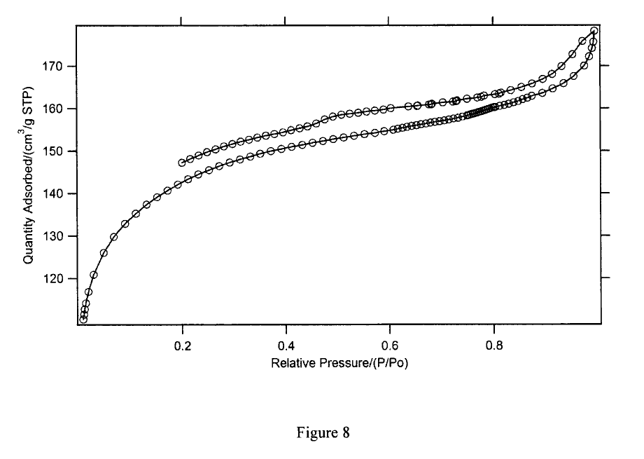

An adsorption isotherm of nitrogen at 77K performed on the sample indicates both microporosity and mesoporosity in the material (FIG. 8). The steep initial rise of adsorption from a relative pressure of 0 to approximately 0.05 is indicative of micropores, while the irreversible hysteresis loop at higher relative pressure range is associated with mesopores. Because pores in carbon materials are typically considered to be slit shapes, the Horvath-Kawazoe analysis gives more accurate information regarding the porosity than the BJH method. The analysis indicated that the sample has a high degree of microporosity, having a micropore volume of 0.2125 cm³/g, which accounts for 77.1% of the total pore volume of the material. The mesopore volume of the material is 0.0591 cm³/g accounting for 21.4% of the total pore volume. It is shown that 98.5% of the total pore volume is micro- and meso-porosity, suggesting the material is ideal for gas phase adsorption applications, such as elimination of Sox from exhausted gases and fuel gases storage.

The sample has a Brunauer-Emmett-Teller (BET) specific surface area of 487.6 m²/g, which is comparable to that of common organosolv lignin carbon. It is noted that this value is not optimized, it is expected that variation of the processing parameters will significantly affect the surface area. This value is greater than the 345.8 m²/g value obtained from polyacrylonitrile (PAN) carbon fiber (carbonized at 800 C) produced using ice-templating, but lower than the 1200 m²/g value obtained from electrospun-derived Alcell lignin carbon fiber (carbonized at 900 C). However, further activation of the material using physical and chemical approaches would enable an increase its BET specific surface area, if higher porosity property is preferred.

### Thermogravimetric Analysis (TGA)

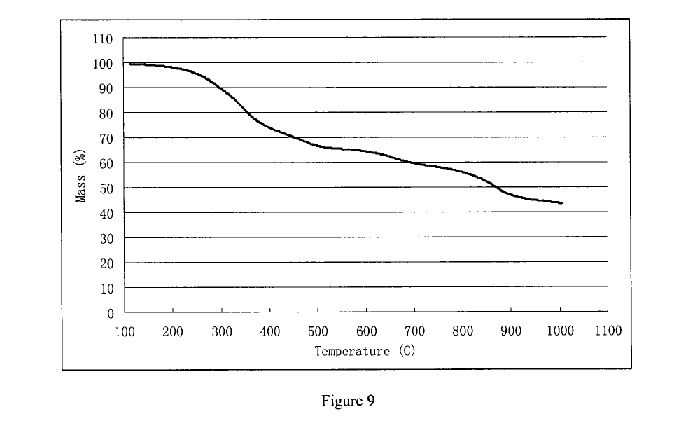

The mass loss of the sample exhibited multistage behavior, with the major mass loss occurring in the temperature range of 200 C-500 C (FIG. 9). The yield at 900 C is approximately 46.5% (average of three replicates, covariance (COV) of 2.6%) of the original dry mass of the sample, which is close to the yield of carbonized hardwood kraft lignin fiber, and falls in the yield range (40-45%) of PAN carbon fibers.

### X-Ray Photoelectron Spectroscopy (XPS):

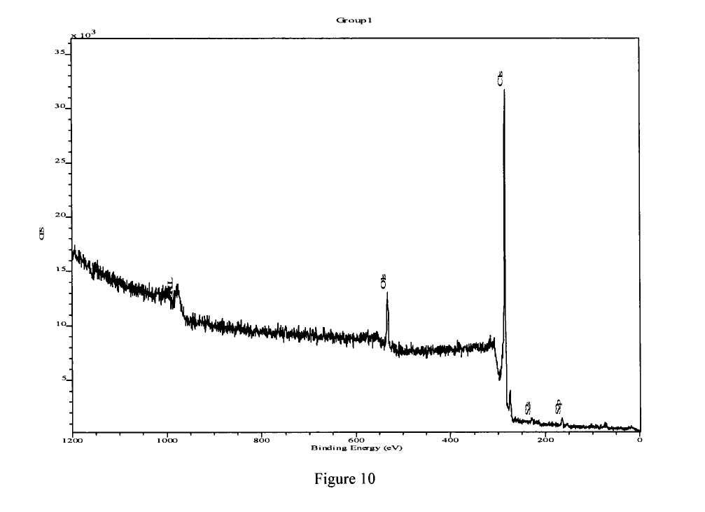

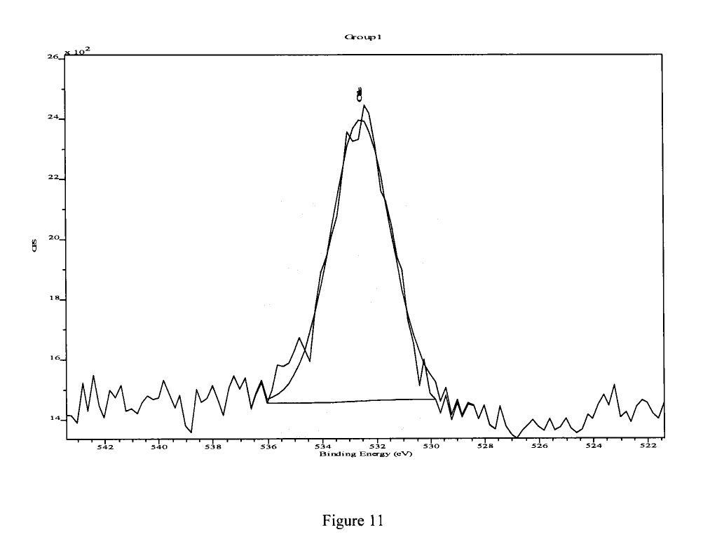

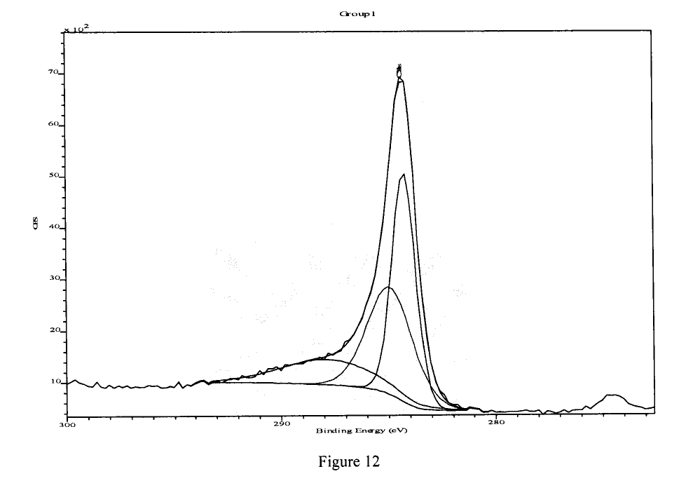

The carbon nano material produced from flash frozen and freeze-dried lignin contains 92.5% carbon, 5.9% oxygen, and 1.6% sulfur, as calculated from a wide-range XPS scan (FIG. 10). FIG. 10 shows the X-ray photoelectron spectroscopy (XPS) spectra of the carbon sample showing intensity (CPS, counts per second) versus binding energy for carbon element 1s electron, oxygen element 1s electron, and sulfur element 2s and 2p electrons. Most of the sulfur was likely present in the original lignin sample due to the Kraft process used in its isolation. The oxygen displayed one state at 532.6 eV (FIG. 11), corresponding to oxygen atoms singly bonded to sp3 carbons. The carbon showed three states (FIG. 12) with peaks at 284.2 eV, 285.0 eV, and 287.8 eV, corresponding to graphite/condensed aromatic carbon (42.7%), aliphatic carbon (38.5%), and C═O carbon (18.8%), respectively. The carbon composition is typical of non-graphitizable carbon materials, and similar to carbon from wood. The carbon content of the sample is comparable to that of the electrospun carbon nanofiber from Alcell lignin.

### X-Ray Diffraction (XRD):

The carbon nano material produced by carbonization of flash frozen and freeze-dried lignin at 900 C is an amorphous carbon material. No characteristic peaks associated with turbostratic carbon structures were observed from the 10 degree to 90 degree range of 2 θ in the θ-2 θ scan of the sample. The results suggest that the carbon material is more reactive than graphitic carbon and has a great potential for using as a carbon template/precursor for carbide ceramic nano materials. In addition, the carbonized lignin nanomaterial of the invention is also a candidate for production of fibrous carbon materials with very high surface areas, because of the poor crystalline structure.

### X-Ray Absorption Measurements:

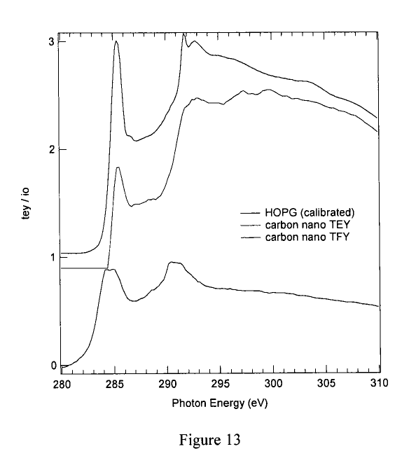

The x-ray absorption spectra of the C K-edge were measured at beamline 8.0.1 at the Advanced Light Source, Lawrence Berkeley National Laboratory using the near-edge x-ray absorption fine structure (NEXAFS) method. The spectra in both total electron yield (TEY) mode and total fluorescence yield (TFY) mode were recorded to obtain surface-sensitive and bulk-sensitive data of the material respectively. The TEY spectral profile is similar to that of highly ordered pyrolytic graphite (HOPG) but is quite different from that of TFY spectrum (FIG. 13), suggesting that the material has a hybrid structure, with the surface being more graphitic than the core. The TFY spectrum shows the material as a bulk is largely non-graphitic/amorphous, a finding consistent with those from the XPS and XRD tests.

### Helium Density:

The carbon nanomaterial produced by carbonization at 1000 C of flash frozen and freeze-dried lignin has a helium density of 1.9328 g/cm³, which is lower than that of graphite (2.25 g/cm³). Application of the rule of mixtures suggests that the material contains approximately 14% closed pores/voids, assuming the density of the voids is zero and the material has negligible impurities.

### 3. Freeze Casting of Polyacrylic Acid in Water

A 0.1% aqueous mixture of carboxymethylcellulose by weight was made in a glass beaker by stirring the polymer into 18.2 Mohm-cm. water overnight. A small amount of polymer mixture was flash frozen by injecting it directly into liquid nitrogen. The frozen mixture composition was then placed in a freeze drying apparatus (SP Industries, model No. FM35EL-85) under partial vacuum of 15 mtorr for approximately six to eight hours. A SEM of the resulting polyacrylic acid polymer cast is depicted in FIG. 2.

Referring again to the invention more generally, suggested applications for numerous examples and embodiments of materials according to the present invention have been provided based upon known and predictable properties attributable to specific structural geometries and dimensions. However, it should be noted that additional beneficial properties relating to specific material embodiments are likely to exist and that the same embodiments may also be useful for purposes un-described. For instance, porous lignin polymer cast materials as depicted in FIG. 4 may indeed be carbonized and used for storing gases, yet the same materials may be added to plastic composites to greatly improve their strength. Similarly, highly fibrous materials such as depicted in FIG. 5 may be used to make carbon materials which separate various molecular mixtures by van der Walls or London forces, although materials organized as the polymer structure of FIG. 4 are likely to perform better for such purposes.

It will be appreciated to those skilled in the art that the present invention, when practiced on a commercial scale, offers numerous polymer cast materials produced by a range of similar processes. As such, particular processes and materials may be selected which are best suited for efficient production yet result in structures which perform slightly less optimally than other embodiments within the scope of the present invention.

### 4. Production of Lignin Nanofiber Mats

Lignin based nanomaterials may be produced by rapidly freezing a dilute solution of lignin. For this specific example the solution was 0.1 wt % lignin in deionized water. Ammonium hydroxide (14.8 M) was added to raise the pH to 10.5. The mixture was placed in a round bottom flask equipped with a refluxing condenser and heated in an oil bath to 75° C. with constant stirring at 250 rpm. The solution was maintained under these conditions for 2 hours. The solution was subsequently allowed to cool to room temperature before being placed into a vessel pressurized with air at 70 PSI. The liquid flow rate delivered from the vessel was controlled via a needle valve, a flow rate of 54 mL/min was selected. The fluid stream was passed through a 0.01″ diameter needle toward a rotating steel drum. The needle tip was placed between 2 and 7 mm away from the drum, positioned perpendicularly to the drum, and parallel to the surface the process was performed on. The drum was previously tempered to −196° C., via running partially submerged in a reservoir of liquid nitrogen. A thin film of liquid nitrogen was present on the drum surface. Liquid nitrogen was periodically added to the drum reservoir to ensure it remained tempered. The drum was rotating with a tangential velocity of approximately 0.815 m/s. Upon striking the thin liquid nitrogen film/drum surface a portion of the lignin solution froze rapidly before the momentum imparted to it from the drum resulted in it leaving the drum as a continuous ribbon. It should be noted also that vaporization of a portion of the liquid nitrogen film due to removal of energy from the lignin solution may contribute to the release of the frozen lignin ribbon from the drum. The contact time of the lignin solution with the drum is of the order of 0.016 s, calculations demonstrate that the resultant cooling rate is approximately 0.188 kJ/s. A collection vessel containing liquid nitrogen was placed on the opposite side of the drum from the needle to collect the frozen lignin ribbon coming off the drum. The rotational speed of the drum was optimized to ensure the material was collected in the vessel.

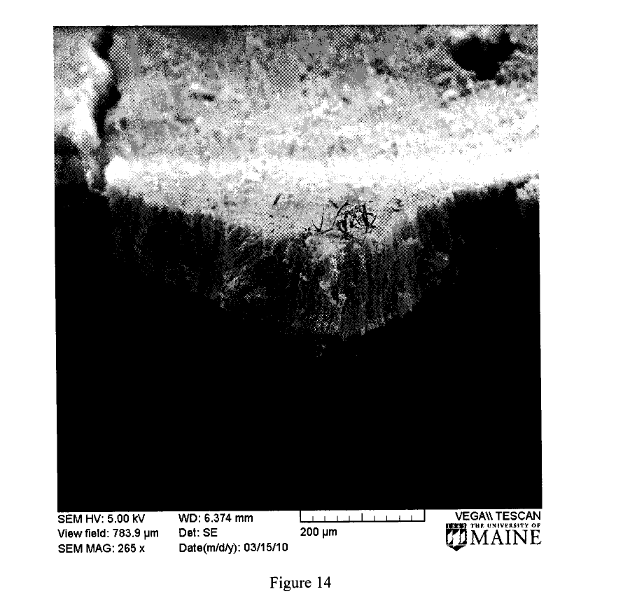

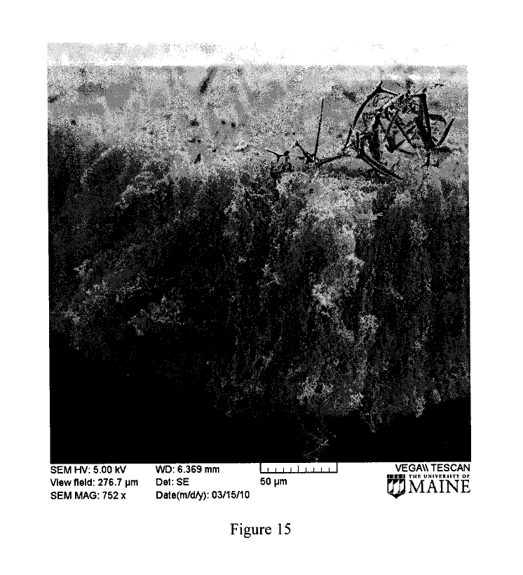

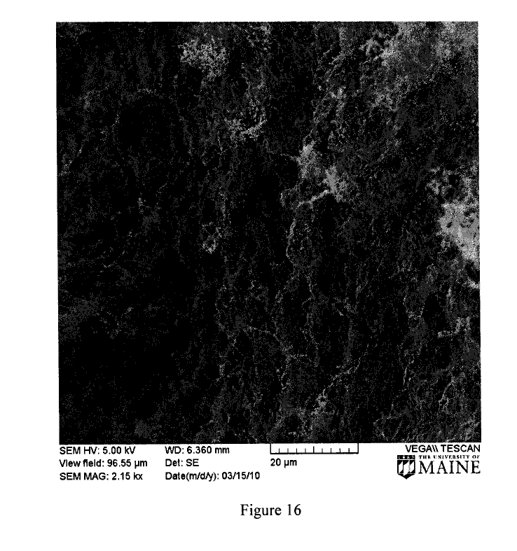

The frozen material was subsequently placed into a freeze dryer and the frozen water was removed by sublimation/lyophilization to liberate the nanolignin structure. The resulting lignin nanomaterials were transferred into a furnace where they were thermally stabilized in air prior to being carbonized. The material was heated in air to 105° C. at a rate of 1° C./min, upon reaching the temperature setpoint it was held at this temperature for a period of 1 hour. It was subsequently heated to 200° C. at a rate of 0.25° C./min, upon reaching the temperature setpoint it was held at this temperature for 18 hours. The atmosphere of the oven was subsequently purged with argon, and the temperature increased at a rate of 10° C./min to 1000° C. with a constant argon flow rate of 10 scf/hr. The material was held at 1000° C. for a period of 45 minutes, before being cooled to ambient temperature. A sample scanning electron micrograph of the carbon nanomaterial produced via this process is given in FIG. 14. FIGS. 15 and 16 provide views of the fibrous nanostructure at higher magnifications.

Another aspect of the invention includes nanostructures forming a non-woven mat-type structure. As can be observed in FIG. 14, the carbon nanofibers making up the mat are substantially all oriented in the direction of the freezing front. For the purposes of this aspect of the invention, substantially all means about 90% or more of the total amount of nanofibers are oriented in the same longitudinal direction. This structure is potentially desirable for multiple applications and is able to be consistently reproduced using this method. The nanofibers individually may have a diameter between about 20 nanometers and about 300 nanometers and lengths of at least 5 microns. Additionally, some aspects of the invention may be used to produce nanofibers with a narrow range of fiber diameters, for example, nanofibers with diameters falling within a range of 20-50 nanometers in diameter.

As an example of the types of energy reductions and associated freezing rates achievable within the scope of the invention, an exemplary calculation based upon example 4 is provided. Without being held to any particular theory, and for the purposes of this example only, the calculations were made assuming that the polymer mixture was completely frozen by the time it was ejected from the drum, that the frozen material was cooled only exactly to its freezing temperature before it left the drum, and that half of the fluid stream from the needle tip splattered and was not frozen by the drum. It should be noted that it is contemplated, and perhaps even likely, that the frozen material is cooled far below its freezing temperature before it leaves the drum and this would result in a larger effective cooling rate.

The following conditions apply to the calculated effective freezing rate and are not intended to be limiting:

### Tangential Velocity of Drum

The drum is attached to a 12 volt motor with an adjustable power supply, the speed of which varies linearly with the input voltage. The diameter of the drum (D) is 3.5 inches and the rotational rate of the drum (W) is 175 revolutions per minute (rpm). Given these conditions, the tangential velocity of the drum is represented by v and may be calculated as follows:

v=W×π∴D

v=175 rpm×π×3.5 inches

v=1,924 inches per minute=0.815 meters/second

Contact Time of Polymer Cast with Drum

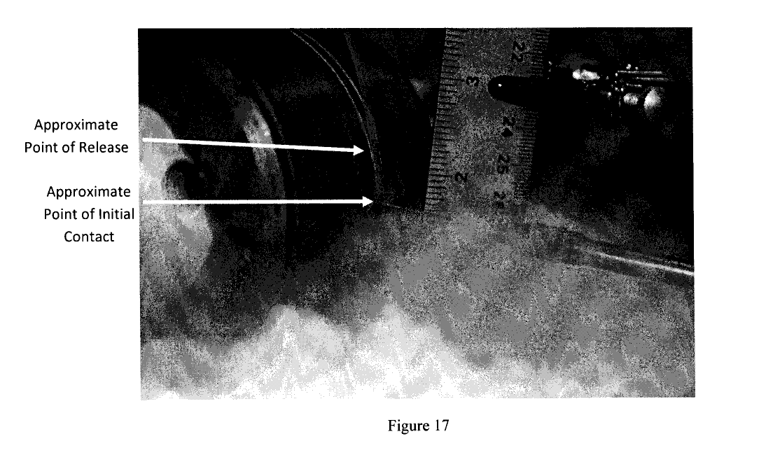

FIG. 17 shows the point of contact with the drum/liquid nitrogen film. As shown in FIG. 17, the frozen polymer cast detaches approximately 0.5 inches after the contact point of the stream from the needle. However, the actual point of release may be anywhere between the point of contact and the 0.5 inch point. If the actual point of detachment is less than 0.5 inches, the associated calculations would be affected accordingly. For the purposes of this example only, however, it will be assumed that the point of detachment is 0.5 inches from the point of contact exactly. With the distance the polymer mixture is in contact with the drum (x) being equal to 0.5 inches, and with the tangential velocity of the drum (v) being equal to 1,924 inches per minute, the contact time of the polymer mixture with the drum (t) may be calculated as follows:

t=x/v

t=0.5 inches/1,924 inches per minute

t=2.7×10⁻⁴ minutes, or 0.016 seconds

### Rate of Energy Reduction

Given these calculations, the cooling rate, in joules per second (Q), may be calculated as follows with the following assumptions: the specific heat capacity of the solution (cₚ) is equal to 4.186 joules per grams Kelvin, the enthalpy of fusion of the solution (ΔH_{f})is equal to 333.55 joules per gram, the temperature change of the fluid stream from ambient temperature to the freezing point is equal to 20 Kelvin, the mass flow rate of the fluid stream frozen by the drum (xm) is equal to 1.002 grams per milliliter×54 milliliters per minute×50%=27 grams per minute. Thus, the energy removed from the polymer cast may be calculated as follows:

Q=xm (cₚ+ΔT+H_{f})

Q=27 grams per minute×(4.186 joules per gram Kelvin×20 Kelvin+333.55 joules per gram)

Q=0.188 kilojoules per second

The above values for cₚ and ΔH_{f} were equivalent to the values for water and were used in this example calculation because the solution is very dilute, making these assumptions an effective approximation.

### Effective Cooling Rate

The bulk of the energy removed from the polymer cast by the drum/liquid nitrogen film is due to the freezing process itself (the latent heat of fusion term makes a much greater contribution than the specific heat capacity term) due to the change in state from liquid to solid. If the energy removed due to the latent heat of fusion was employed to reduce the temperature only, without regard to the change in the state of matter, than an 80 Kelvin temperature change would result. So, if one adds the 80 Kelvin equivalent temperature change to the 20 Kelvin temperature change incorporated above, the result is an effective cooling rate of 100 Kelvin in a 0.016 second period. This equates to an effective cooling rate of 6,250 Kelvin per second. For clarity, the effective cooling rate is defined as the change in energy in a system over a particular period of time represented as a pure temperature change of liquid phase water, wherein the energy involved in the change of matter state is converted to an equivalent temperature change of liquid state and an example of this is captured by these calculations.

Referring now to the invention more generally, carbon materials containing consistent nanopores, as may be produced according to aspects of the invention, including carbonizing the polymer morphology, demonstrate a variety of beneficial properties relating to high pore volumes and large surface areas. Such materials may be used to adsorb gases as is needed for gas fuel storage. In other applications, such materials may be used as molecular filters, sieves, catalysts, catalyst supports, and electrodes.

Cast formations of the present invention may be molded in frozen liquid from polymers which are already significantly preformed prior to being mixed. In examples 1 and 2 above, the lignin used is significantly polymerized prior to being added to aqueous solution. Polymers preferred for use in certain aspects of the invention are easily miscible yet quickly form cast formations when frozen in homogeneous liquid mixtures. However, polymers that are not easily miscible and polymers that form during mixing are also contemplated as within the scope of the present invention.

The term “or” as used refers to a non-exclusive alternative without limitation unless otherwise noted. Similarly, the use of “including” means “including, but not limited to,” unless noted otherwise.

While several aspects of the present invention have been described and depicted herein, alternative aspects may be effected by those skilled in the art to accomplish the same objectives. Accordingly, it is intended by the appended claims to cover all such alternative aspects as fall within the true spirit and scope of the invention.

1. A method of forming a carbon nanostructure from a pre-formed polymer comprising the steps of:
mixing said pre-formed polymer with a liquid to form a polymer mixture;
freezing said polymer mixture at an effective freezing rate greater than or equal to 10³ Kelvin per second to form a polymer cast within said frozen liquid;
separating said polymer cast from said frozen liquid by sublimating said frozen liquid; and
carbonizing said polymer cast to form a carbon nanostructure.

2. The method of claim 1, further comprising stabilizing the polymer cast subsequent to the separating step and prior to the carbonizing step.

3. The method of claim 2, wherein the stabilizing step is performed by heating the polymer cast to a temperature between about 200 degrees Celsius and about 300 degrees Celsius.

4. The method of claim 1, further comprising graphitizing the nanostructure.

5. The method of claim 2, further comprising graphitizing the nanostructure.

6. The method of claim 1, wherein the carbon nanostructures formed are greater than or equal to about 25% carbon by weight.

7. The method of claim 1, wherein the amount of pre-formed polymer is about 0.01% to about 2.5% by weight of the polymer mixture.

8. The method of claim 1, wherein the carbonizing step is performed under inert atmospheric conditions.

9. The method of claim 1, wherein the pre-formed polymer is selected from the group consisting of lignin, carboxymethylcellulose, polyacrylic acid, cellulose, natural polymers, modified natural polymers, synthetic polymers, homopolymers of polyacrylates, homopolymers of polysulfonates, homopolymers of polyphosphates, copolymers of polyacrylates, copolymers of polysulfonates, copolymers of polyphosphates, polyacrylic acid, polymethacrylic acid, polystryrenesulfonic acid, guar and xanthan gums, cationic, anionic amphoteric and non-ionic starch, polyvinyl alcohol, polyethylene oxide, polyacrylonitrile, proteins, polysaccharides, polyethylene, polypropylene, polytetrafluoroethane, polyethyleneteraphthalate, polyvinylacetate, polyvinyl chloride, nylon, elastomers, polyesters and polyacrylimide.

10. A nanostructure formed according to the method of claim 1.

11. A nanostructure formed according to the method of claim 1, wherein the nanostructure has a plurality of geometric features having at least one dimension measuring less than one micrometer.

12. The nanostructure of claim 11, wherein the geometric features are selected from the group consisting of planar sheets, micropores, mesopores, spheres, platelets, tubes, cones, and fibers.

13. A method of forming a carbon nanostructure comprising the steps of:
mixing a monomer, oligomer, or combination thereof with a liquid;
polymerizing said monomer, oligomer, or mixture thereof in said liquid to form a polymer mixture;
freezing said polymer mixture at an effective freezing rate greater than or equal to 10³ Kelvin per second to form a polymer cast within said frozen aqueous solution;
separating said porous polymer cast from said frozen aqueous solution by sublimating said frozen aqueous solution; and
carbonizing said porous polymer cast to form a carbon nanostructure.

14. The method of claim 13, further comprising stabilizing the polymer cast subsequent to the separating step and prior to the carbonizing step.

15. The method of claim 13, further comprising graphitizing the porous carbon nanostructure.

16. The method of claim 13, wherein the pores in the carbon nanostructure are substantially all less than about 100 nanometers in diameter.

17. The method of claim 13, wherein the carbon nanostructures formed are greater than or equal to about 25% carbon by weight.

18. The method of claim 13, wherein the amount of pre-formed polymer is about 0.01% to about 2.5% by weight of the polymer mixture.

19. The method of claim 13, wherein the carbonizing step is performed under inert atmospheric conditions.

20. The method of claim 13, wherein the pre-formed polymer is selected from the group consisting of lignin, carboxymethylcellulose, polyacrylic acid, cellulose, natural polymers, modified natural polymers, synthetic polymers, homopolymers of polyacrylates, homopolymers of polysulfonates, homopolymers of polyphosphates, copolymers of polyacrylates, copolymers of polysulfonates, copolymers of polyphosphates, polyacrylic acid, polymethacrylic acid, polystryrenesulfonic acid, guar and xanthan gums, cationic, anionic amphoteric and non-ionic starch, polyvinyl alcohol, polyethylene oxide, polyacrylonitrile, proteins, polysaccharides, polyethylene, polypropylene, polytetrafluoroethane, polyethyleneteraphthalate, polyvinylacetate, polyvinyl chloride, nylon, elastomers, polyesters and polyacrylimide.

21. A nanostructure formed according to the method of claim 13.

22. A nanostructure formed according to the method of claim 13, wherein the nanostructure has a plurality of geometric features having at least one dimension measuring less than one micrometer.

23. The nanostructure of claim 22, wherein the geometric features are selected from the group consisting of planar sheets, micropores, mesopores, spheres, platelets, tubes, cones, and fibers.

24. A carbon nanostructure comprising:
a plurality of carbon nanofibers, wherein about 90% or more of the carbon nanofibers are oriented in the same longitudinal direction and each individual nanofiber has a diameter of less than about 300 nanometers and a length of at least 5 microns.

25. An apparatus for forming carbon nanostructures comprising:
a means for freezing a liquid material at an effective freezing rate greater than or equal to 10³ Kelvin per second;
a means for depositing said liquid material on said means for freezing forming a frozen liquid material; and
a means for receiving said frozen liquid material, wherein said liquid material is a polymer mixture.

26. The apparatus of claim 25, wherein said means for freezing said liquid material is a cryogenic liquid or a material cooled by a cryogenic liquid.

27. A method of forming substantially non-aggregated nanofibers comprising the steps of:
suspending an organic polymer, or fibers containing organic polymers, in a liquid suspension to form a polymer mixture;
freezing said polymer mixture at an effective freezing rate greater than or equal to 10³ Kelvin per second to form a polymer cast within said frozen aqueous solution; and
separating said porous polymer cast from said frozen aqueous solution by sublimating said frozen aqueous solution to form substantially non-aggregated nanofibers.

28. The method of claim 27, wherein the pre-formed polymer is selected from the group consisting of lignin, carboxymethylcellulose, polyacrylic acid, cellulose, natural polymers, modified natural polymers, synthetic polymers, homopolymers of polyacrylates, homopolymers of polysulfonates, homopolymers of polyphosphates, copolymers of polyacrylates, copolymers of polysulfonates, copolymers of polyphosphates, polyacrylic acid, polymethacrylic acid, polystryrenesulfonic acid, guar and xanthan gums, cationic, anionic amphoteric and non-ionic starch, polyvinyl alcohol, polyethylene oxide, polyacrylonitrile, proteins, polysaccharides, polyethylene, polypropylene, polytetrafluoroethane, polyethyleneteraphthalate, polyvinylacetate, polyvinyl chloride, nylon, elastomers, polyesters and polyacrylimide.

29. The method of claim 27, wherein the amount of organic polymer is between about 0.01 wt % and about 2.2 wt % of the polymer mixture.

30. The method of claim 27, wherein about 95% or greater of the nanofibers formed are non-aggregated.
